(19) United States
(12) Patent Application Publication
(10) Pub. No.: US 2009/0099853 A1
(43) Pub. Date: Apr. 16, 2009

(54) CONTEXTUAL PRODUCT PLACEMENT

(76) Inventor: Greg M. Lemelson, Southborough, MA (US)

Correspondence Address: ANTOINETTE G. GIUGLIANO, P.C.;DBA AGG Intellectual Property Law, 100 Cummings Center, Suite 454C, Beverly, MA, 01915, US

(21) Appl. No.: 11/870,137

(22) Filed: Oct. 10, 2007

(51) Int. Cl. G06Q 99/00

(52) U.S. Cl. 705/1

(57) ABSTRACT

The present invention relates to methods, systems and databases for sharing user inputted data obtained from two different environments. In particular, the present invention relates to methods of obtaining user inputted data (e.g., metadata or links) from a social networking environment, and providing the data to other users in an e-commerce environment, and vice versa. Data from both environments can be stored in a database accessible by either environment. In another embodiment, a user can access the data via a search performed or provided to the user in realtime.

### BACKGROUND OF THE INVENTION

Social networking websites allow users to connect with one another, and this connection often occurs through common interests or ties. For example, social networking sites allow users to connect for various reasons such as romantic involvement, friendship, professional connections and common interests. Often, the revenue generating aspects of these websites include advertising, or possibly a use and/or membership fee.

E-commerce websites generally allow users to purchase goods and/or services. Such sites can be an online retailer or distributor, or auction site. Many of these websites generate revenue, among other ways, through the sale of goods, fees for each sale, and advertising.

A need exists to integrate social networking data, inputted by the user, with the sale of goods and/or services, and vice versa. A further need exists for social network sites to generate revenue as the result of user inputted data generated on an e-commerce site (e.g., offering goods and/or services for sale on a social networking site, based on user-inputted data). Another need exists for e-commerce sites to generate revenue or sales leads through user generated data of particular product or service that was provided on a social network setting. Yet another need exists to allow users to perform searches and obtain results that contain user-inputted data from different types of settings, including social networking environments as well as e-commerce environments.

### SUMMARY OF THE INVENTION

The present invention pertains to methods for sharing data (e.g., metadata, links, or combination of both) inputted by a user in a first environment. The data can be attached to or associated with an object (e.g., text, an image, a video, webpage or combination thereof). The methods include providing user inputted data from the first environment to a second environment, wherein the first environment and the second environment are different types of environments. The methods include making the user generated data part of a database accessible to the second environment, or associating the user generated data with data present in the second environment. Preferably, the first environment and/or the second environment is a social networking environment and/or an e-commerce environment.

The present invention embodies methods of providing a database of user inputted data (e.g., metadata, links, or combination of both), by obtaining the user inputted data and/or information about the object to which the data are associated, from a first environment and a second environment, wherein the first and second environment are different types of environments. The methods further include associating one piece of user generated data from the first environment with a second piece of user generated data obtained from the second environment, and storing the user generated data. The method further embodies a step in which the first and second pieces of data are retrieved by a user.

In one aspect, methods of the present invention include searching a database using a graphical user interface, wherein the method involves inputting a search string; searching a database having user inputted data (e.g., metadata, links, or combination of both) obtained from a social networking environment, and user inputted data obtained from an e-commerce environment; and providing an output of results. Providing an output of results involves providing two or more pieces of user inputted data obtained from the e-commerce environment and from the social networking environment.

In another embodiment, the methods of the present invention relate to methods of providing user inputted data in a first environment to a first user (e.g., in real-time), wherein the user inputted data are attached to or associated with an object. The method includes associating data inputted by a second user in a second environment with data from the first user; and providing the user inputted data and information about the object to the first user. The first and second environments are different types of environments, and the first or second environment is a social networking environment, or an e-commerce environment.

Methods of the present invention include providing an output having more than one piece of user generated data obtained from at least two different types of environments by associating the user generated data inputted by one or more users; and providing the output (e.g., a screen display, written to a file, sent to a printer, sent in an email text message, or facsimile) having the user generated data.

The present invention, in one aspect, pertains to a database with at least one piece of data inputted by a user from a first environment; at least one piece of data inputted by another user from a second environment. The user inputted data are associated to at least one other piece of user inputted data and/or with information about the object to which the user inputted data are attached. As described herein, the first environment and second environment are different types of environments (e.g., a social networking environment or an e-commerce environment).

A system or computer apparatus for providing data inputted by a user in a first environment is also encompassed by the present invention. The system or apparatus includes a source of data inputted by a user in a first environment; a processor, coupled with the source, that associates the data with data of a second user in a second environment; and an output device (e.g., monitor, phone, printer, file) that provides the user generated data to the second user, e.g., via a screen output using a graphical user interface, email, printer output, file output, facsimile, text message, etc.

The present invention relates to methods of providing data and one or more objects in an online environment. The methods include providing an object having user inputted metadata and product data of a product, wherein the user inputted metadata and product data is associated with the object or is imbedded into the object. The methods also include providing one or more pieces of product information about the product, wherein the information relates to retailers, cost of the product, location of the product, repair information about the product, or reviews, ratings or reviews about the product. In an embodiment, the product data imbedded as metadata into the object is inputted by the user or generated by the user (e.g., by taking a picture with a camera which automatically embeds metadata into the image). In one embodiment, the product involved in the methods of the present invention include relates to photography equipment, cameras, or accessories therefor. In an embodiment, the object is image or video taken by a camera. The methods also include providing information about the user who uploaded the object, links to the user's profile, or links to communicate with the user.

In yet a more specific embodiment, the methods of the present invention involve providing data and one or more images in an online environment. The steps include providing an image having user inputted metadata and product data of a product, wherein the user inputted metadata and product data is associated with the image or is imbedded into the image; and providing one or more pieces of product information about the product, wherein the information relates to retailers, cost of the product, location of the product, repair information about the product, or reviews, ratings or reviews about the product. The images provided can be filtered by one or more settings defined by the user. The results of the images can be filtered with photography attributes (e.g., date and/or time the photograph was taken, location where the photograph was taken, camera make, camera model, presence or absence of a flash, aperture, shutter speed, white balance, contrast, saturation, focal length, ISO speed, or any combination thereof). The images can also be part of a result set obtained by conducting a search of the metadata associated with the images. The results of the search contain the images having metadata relating to or matching search criteria.

The advantages of the present invention include allowing a user greater access to relevant user generated content, namely, that entered in different types of environments such as social networking and e-commerce environments. The present invention gives richer, and more comprehensive sets of results. The integration of social networking and e-commerce through user-inputted data provides a more versatile environment and allows the user to combine experiences and opinions of others with the sale or information of goods and services. In a particular embodiment, the present invention allows a user to assess products (e.g., cameras) by comparing objects (e.g., images) having user generated/inputted metadata and product metadata, thereby providing rich and meaningful search results or comparisons.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic diagram showing the flow of user generated data for the methods of the present invention.

FIG. 2 is a block diagram employing the integration of user-inputted data from social networking and e-commerce environments.

FIG. 3 is a schematic diagram showing the integration of social networking environments, e-commerce environments, media sources, and location/mapping services.

FIG. 4 is a website screen printout of an embodiment of the present invention involving popular location images having imbedded metatags including the name of the location.

FIG. 5 is a website screen printout of an embodiment of the present invention involving a slide show of images having metatags of a specific location (e.g, leaning tower of Pisa), filtered using default settings.

FIG. 6 is a website screen printout of an embodiment of the present invention involving a slide show of images wherein when a user clicks on one of the images, links to the product (e.g., picture of the camera with “More”) and user information (e.g., picture of the user with “More”).

FIG. 7 is a website screen printout of an embodiment of the present invention wherein when clicking on the product link, retail, pricing and auction information is provided.

FIG. 8 is a website screen printout of an embodiment of the present invention wherein when clicking on the user link, additional links to the user profile, and this or other images are provided.

FIG. 9 is a website screen printout of an embodiment of the present invention wherein the user can choose to sort results based on the most popular locations worldwide (e.g. “Popular”), or popular locations that are nearby (e.g., “Local”).

FIG. 10 is a website screen printout of an embodiment of the present invention that provides a toggle between filtering results based on the metadata having location information (e.g., geotags), products, or users that have uploaded images (e.g. People).

FIG. 11 is a website screen printout of another embodiment of the present invention showing the user of the “Product” toggle, wherein the product is a camera.

FIG. 12 is a website screen printout of an embodiment of the present invention showing results from a search for a specific location (“Leaning Tower of Pisa”) of images having metadata that matches the search string and filtered by the attributes indicated (e.g., f/8.0 Aperture and 1/60 sec Shutter Speed).

FIG. 13 is a website screen printout of yet another embodiment of the present invention that provides a menu of settings (e.g., photograph attributes) that the user can use to find images having the settings the user chose.

FIG. 14 is a website screen printout of another embodiment of the present invention showing the user of the “People” toggle, wherein the people refer to users that have uploaded images having location metadata.

FIG. 15 is a website screen printout of an embodiment of the present invention showing how a user conducts a search for a specific search string (e.g., Leaning Tower of Pisa) for images uploaded within a specific time frame (e.g., within the last 10 minutes).

FIG. 16 is a website screen printout of another embodiment of the present invention showing a user display of users having uploaded images taken with a specific camera (e.g., Nikon D40), wherein the user display includes a map showing the user's location and the images taken by the users with the specific camera.

### DETAILED DESCRIPTION OF THE INVENTION

A description of preferred embodiments of the invention follows.

The present invention relates to methods, systems and apparatus of an integrated social networking and e-commerce computer-based environment. The methods include gathering and using user-inputted data from a social network environment, and applying the data to an e-commerce setting, and vice versa. In a social networking environment, users can enter user-specific data about themselves, such as a name, address, likes, dislikes, income, interests, hobbies, etc. In addition to this type of data, the user can generate or input content (e.g., user inputted data) including metadata and links, and associate this user inputted data to an object. An object is any online item to which data can be attached or associated (e.g., points to a webpage). Examples of such objects include text, video (e.g., product video or user taken video), images (e.g., product images, user taken images), webpages, or combinations thereof. An object can be in any format now known or developed in the future. Video includes streaming video, movie files, and any format that includes a series of frames. An object can include a file that contains one or more images, video, movie data, and/or audio data. Objects can be made up of one or more files that are in any format now known e.g., jpeg, pdf, tiff, avi, .mov, .mpg, mp3, mp4, .png, gif, psd, and the like or developed in the future.

One example of user generated data that is attached to an object is metadata. In particular, data entered by the user and attached to an object, is referred to herein as “metadata” or “metatags.” Often metadata can be viewed when the user places their mouse over the object to which the data is attached. User generated data refers to data obtained thought the action (e.g., viewing a product, taking a picture, viewing a video, sending an email) performed by a user, whereas user inputted data refers to information inputted by the user (e.g., entering of user profile information, manually entering metatags associated with images). In particular, an example of user generated data includes the action of a user taking a photograph and the camera automatically imbeds metadata that includes a geotag (e.g., metadata having geographical information) and photography attributes (e.g., ISO, aperture, shutter speed, etc.). The term “camera” refers to any device that can take an image or video and includes cameras, mobile devices, personal digital assistants, Ipods®, and the like. Cameras also include other devices that take images or video which are know or developed in the future.

Another example of user generated data includes links or bookmarks. Users submit links to a website that point to or associate with a webpage, image, text, or video. Often other users can assign a value to the link by voting for the link in the particular context, which can convey the link's popularity, importance, or relevance.

Yet another example of user generated data further includes actions performed by the user and recorded or logged by the environment. For example, user generated data items viewed or clicked on by the user.

In an embodiment, the data used for the present invention are data that are preferably input or generated by one or more users, or is otherwise described herein as “wiki” data. Wiki data refer to data built upon a user's input, and preferably built upon multiple users' input. Users can attach data to various objects, such as text, images or video, to provide a library of metadata, or provide data in the form of links that are associated to an object such as a webpage. “User inputted data” and “user generated data” are used interchangeably.

Such data are entered using a graphical user interface, or an interface known in the art, or later developed. Software that can be used to create, in part or in whole, such an interface includes, e.g. e.g., AJAX (Asynchronous Java and XML) software, DreamWeaver, and FLASH software, javascript, php, css, asp, cold fusion, jsp ruby, ruby on rails, and the like. An interface refers to any mechanism by which an external user or computer can obtain and provide data. Additionally, layers of software can be applied. For example, a Decay feature can be used to refresh webpages that are viewed by users more frequently (e.g., have more traffic) with any updated or pertinent user information, as compared with webpages that are less frequently viewed.

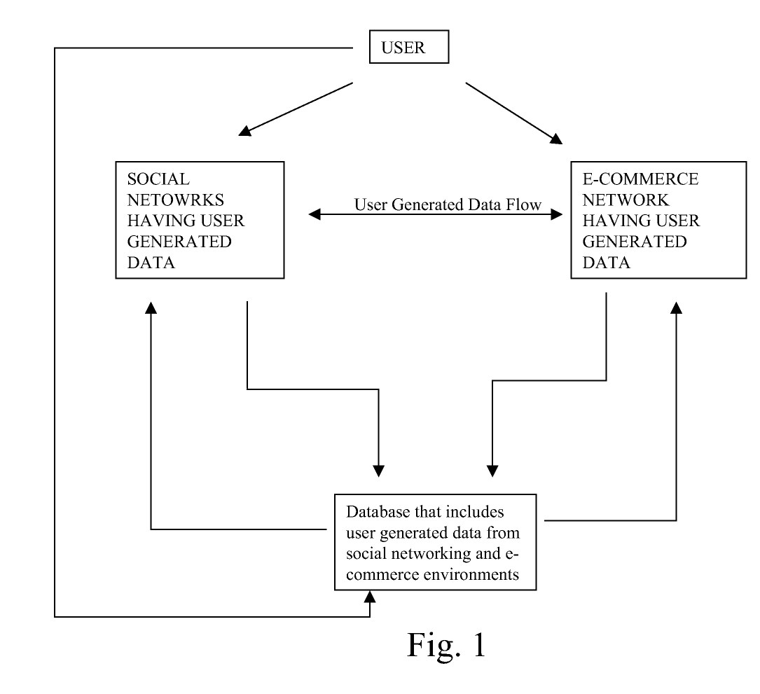

Referring to the schematic diagram in FIG. 1, the user inputted data obtained from a social networking site and an e-commerce site are shared, saved or made part of a database, or a combination thereof. Combining user inputted data in a database, or allowing for the flow or exchange of user generated data between these two types of environment is encompassed by the methods of the present invention, and is utilized in methods of searching for information, and/or providing information.

The present invention involves method of obtaining or combining user inputted data from a social networking environment and an e-commerce environment. A social networking environment is an environment that allows users to connect to other users (e.g., through postings, chat rooms, blogs, emails, etc.). An e-commerce environment is one that involves the sale, auction, information or exchange of goods and/or services. Product data referred to herein as data obtained from an e-commerce environment, and for example, refers to one or more pieces of information regarding a product including retailers, pricing, location of the product, location of the retailers, reviews, ratings, comments, repair records, etc. Ratings, reviews and comments are often user generated. A website often deals mainly in one area or the other, but the two environments can be combined into one website, or otherwise one can have one or more features of the other. The present invention relates to the exchange or sharing of user generated data obtained in an e-commerce setting and user generated data obtained in a social network setting, even if the settings are on the same website, different websites, websites owned by the same, different or related companies. Accordingly, “environment” refers to a setting in which e-commerce or social networking can occur, including those on the same or different websites. The social networking and e-commerce environments described herein are part of an internet, e.g., a collection of interconnected networks that are linked together to form a global network.

The present invention encompasses methods for providing or storing user inputted data to a database, wherein the database contains user generated data obtained from both a social networking environment and an e-commerce environment. In an embodiment, data can be stored in more than one database. All or a portion of the data and/or objects can be accessible through an open Application Programing Interface (API) or similar interface or protocol. For example, open APIs can provide user's personal profile data as well as media (e.g., images and video). Examples of open APIs include Facebook.com, Ebay.com, Amazon.com. The database is a collection of two or more pieces of stored data. Data can be stored in a manner, and in a mode known in the art, or developed in the future. Examples of types of databases that store user generated metadata and links include MY SQL, SQL, and Oracle. The data being stored, whether physically together, or associated with one another, includes the user inputted data and information about the object to which the data are being attached or associated. In addition to providing and/or storing user inputted data collected from a social networking environment and an e-commerce environment, the methods of the present invention also include associating the user inputted data with other types of data including user-specific data (e.g., name, address, email, preferences) about themselves, or product/service specific data, e.g., provided by an e-commerce company.

The association of the user inputted data from one environment to data from another type of environment is preferably performed by a user, but can also be associate by an owner or agent of the website. In the former case, the user can categorize or cross-reference the user generated/inputted data from one type of environment with user generated data from another type of environment. The user can choose the appropriate category, network, or product line, etc. to which user inputted data belongs. The methods of the present invention encompasses a step of cross-referencing or associating user inputted data from two types of environments. The methods further include checks and balances that allow users to confirm or re-categorize/re-associate the user inputted data. Accordingly, the methods include scanning the user inputted data or user history and asking the user if the data is properly categorized.

In an example, users who are photographers and part of an online social network (e.g., Amvona.com) can write about experiences that they have had with a particular camera, and/or place images taken with that camera online. The users can attach metadata to the text or the images taken with the camera to describe not only the type of camera, but how the pictures were taken, where they were taken, what they were used for, accessories used, problems encountered, and solutions found. On the other hand, in an e-commerce environment, the user can enter and attach metadata to their camera, and accessories used for the camera. The metadata can include any information about the goods and/or services. In this example, the user can enter data about how to optimize use of the camera or accessory, repair information, problems, attributes, uses thereof, etc. In another example, the company that makes or sells the camera can include information about the camera as metadata associated with a picture of the camera/product. In an embodiment, the metadata from both environments are cross-referenced or otherwise associated with one another. Hence, when another user performs a search, the results include metadata from both settings. In the example, a user can search for the type of camera, and obtain results that include, in addition to who sells the product and for how much, but also the types of pictures taken, types of users utilizing the product, problems encounter, solutions found, accessories used, and the rest of the user inputted metadata related to the camera. Metadata, as it relates to photographs can specifically include attributes of the photograph and/or the camera used to take the photograph. Examples of such attributes are date and/or time the photograph was taken, location where the photograph was taken, camera make and/or model, presence of a flash, aperture, shutter speed, white balance, contrast, saturation, focal length, ISO speed and the like. These attributes often become metadata associated with the photograph. These attributes can be automatically associated with the photograph by the camera at the time the photograph is take (e.g., automatically embedded in the image/video as metadata), or can be done manually by the user. Accordingly, the methods of the present invention include performing a search with a database having metadata from social networking and e-commerce environments, and providing an output (e.g., screen output, printer output, file output, etc.) of results having metadata from both environments. When a user conducts such a search, s/he will obtain a wealth of information. A user, corporate entity, or organization doing the search can now more easily obtain information input by other users about a specific item, e.g., thing, person, good, services location, concept, etc. for which the user is searching.

In one embodiment, the present invention includes tracking and displaying users that have viewed media, and is referred to herein as a “Traxologie” display. Displaying users that have viewed media refers to displaying user inputted or generated information along with the media. Examples of such information include, the user's user name, user's photograph, date and/or time; length of length of time since the viewing, comments or ratings by the user about the image, skill level, profession, etc. Hence, when a user looks at a product image, the user will also be able to see all of the other users that viewed this product image and when they did so. Results displaying other users who have viewed the media can be sorted chronologically, by user category (e.g., friends, persons in user's network, by profession, by location, etc. Along with the user information of who viewed the media, links can also accompany the tracking and displaying of users who previously viewed the media. For example, along with the user's photo and user ID, a link can be present that allows the current user to send a message (e.g., about the product) or add that person to their network. As described in the exemplification, the tracking and display of users who have viewed images of photography products include the displaying the user's photograph, user ID, the length of time that has passed since the viewing by the user, and links to send the user a message and add them to the current user's network.

In a social networking environment, tracking and displaying of data can also integrate e-commerce aspects. In a user's profile page, product images that the user has viewed can be displayed along with any other user generated/inputted information and/or product information. In such a case, the display includes product images viewed by the users, the user's photo, user's ID, the date and/or time of the viewing, the length of time that has passed since the viewing, other users that have viewed the profile, links, ratings, reviews, etc. Again, the display of this tracking information can be done in chronologically, by rating, product category, etc.

In the embodiment in which user generated data (e.g., metadata or links) between a social networking environment and an e-commerce environment are exchanged, e.g., in realtime, a communication protocol known in the art or developed in the future can be used. In an embodiment, metadata along with information about the object to which it is attached are also exchanged. As shown in FIG. 1, the flow of data between these two environments allows for valuable information to be provided to the user. The present invention includes methods for providing metadata in an e-commerce environment, wherein the metadata have been inputted by a user in a social networking environment, and vice versa.

In the example above, the online users who are photographers have attached metadata to text for a camera, or to images taken with that camera online. As described herein, the user can attach metadata that include a wide variety of information such as how the pictures were taken, where they were taken, what they were used for, accessories used, problems encountered, and solutions found. Based on the information provided by the user, the user in this example and/or users in his network, can receive a variety of related information from an e-commerce environment. For example, the user can receive information about the camera used; accessories that can be used to get better photographs; locations of similar places for another photo shoot; similar photographs taken; potential issues or problems with this camera and products to help correct the problem. Such information can be in the form of banner ads describing sales or specials for the camera, or accessories associated therewith. More specifically, the demographics, description and other information inputted by the user can be used to target products that are more likely to sell. For example, a user that indicates that he is an expert and/or a professional in photography and has friends in his network that are also professional photographers is more likely to buy a higher end, more expensive camera and accessories therefor, whereas a user that identifies herself as a beginner is more likely to buy an automatic, lower end camera. Accordingly, the present invention includes utilizing metadata that were inputted by a user in a social networking environment, to increase e-commerce (e.g., increase the number of sales or this or related items, increase revenues, increase the demand, etc.). The present invention also embodies providing information to a user or to users in this user's network from an e-commerce environment, based on metadata attached to an object in a social network setting. Such information can be provided through a graphical user interface, advertising, providing a link to the data.

In an embodiment, the metadata from the social networking environment and the e-commerce environments are cross-referenced or otherwise associated with one another. Metadata attached to the same object are related. Metadata attached to different objects can be associated to one another using various methods of association. A preferred method of associating user generated data from two different types of environments occurs by the users themselves, as described herein. In another embodiment, the association can be automated. In on aspect, the user inputted data is associated by cross-referencing terms that are identical, or similar. Similar data includes partial matching of same text (e.g., photo and photograph), various versions of a term for the same thing (e.g., car and automobile), various iterations of the same word (e.g., ran and run), etc.

On the other hand, an e-commerce site, in which a user is looking for the particular camera described above, can provide the user with user inputted metadata from a social networking environment (e.g., an image taken by the camera, the type of person who uses the camera (amateur or professional), problems with the camera, benefits of the camera, etc.). The e-commerce site can even suggest the network to the user looking to purchase the camera as a potential resource, or suggest the additional accessories used. As described herein, the metadata from the social networking and e-commerce environments can be cross-referenced or otherwise associated to one another. Accordingly, the present invention relates to methods of providing metadata in an e-commerce environment, e.g., during the search or sale of goods and/or services, wherein the metadata were inputted by a user and obtained from a social networking environment. The methods include allowing a user to browse or conduct a search for an item in an e-commerce environment, and providing metadata that have been inputted by a user and obtained from a social networking environment. As such, the present invention relates to methods of selling goods and/or services that includes providing user input metadata from a social network environment.

As with metadata, user generated links can be submitted in either type of environment, social networking and/or e-commerce. User generated links from both environments and the objects (e.g., webpage) to which they are associated can be stored in a database, and accessed by users. Links that are submitted by a user often point to another website or webpage. User generated links on a social networking site can relate to the network to which the users belongs (e.g., professional camera users posting links that point to articles on how a particular camera was used). User inputted links that appear on e-commerce sites can, for example, relate to the sale of products or related accessories (e.g., user generated links that point to similar used cameras for sale, or accessories therefor). The present invention relates to creating a database that contain user generated links and information about the website to which they point from these different types of environments. The methods further include allowing a user to search such a database and provide results that contain user generated links from a social networking and e-commerce environments (e.g., obtain user generated links for cameras for sale as well as user generated links to professional photographers use of the camera).

As with the metadata, user generated links and websites to which they point can also be exchanged between e-commerce and social networking environments. In an embodiment, the exchange can happen in real time, and on the same or different websites. For example, in the social network of photographers described herein, the site can have a tab that leads to user generated links. The tab contains a variety of links for “deals” on photography equipment, and in particular on equipment described by the members of the social network. The tab that contains these user generated links that point to webpages that sell or exchange photography equipment, is integrated with a social networking environment of the photographs network. Users of the social networking site can vote on the various links to give the link a score. The higher scoring links, in an embodiment, appear more visible to the user like at the top of the page.

Similarly, an e-commerce environment that sells camera equipment can have an environment that includes user generated links from a social networking setting. A social networking site can links relating to webpages that describe locations or types of pictures that the user had taken pictures with the particular camera being sold. The user generated links can be associated with the e-commerce environment by the user, as further described herein, or associated by the owners of the website.

Accordingly, the present invention relates to providing user generated links that point to an e-commerce environment in a social network environment, and visa versa. The methods also include associating the user generated links e.g., by the user, and then providing the links that have been generated.

The present invention relates to a system or computer apparatus for providing data inputted by a user in a first environment. The system includes a source of data (e.g., metadata, links or combinations thereof) inputted by a user in an environment (e.g., a social networking or an e-commerce environment). An online environment refers to accessing or using the internet, or a global network of computers. An environment can be accessed from a variety of output devices including a computer, mobile phone, PDA (personal digital assistant), computerized navigation system, media player (ipod, mp3 player) and the like. Output devices include any device that allows for internet access and an output having the user generated tracking display of the present invention. Output devices include those that are known in the art and those that are later developed. The methods of the present invention, in one aspect, is carried out by a processor on a server and displayed on a website. In another embodiment, software can be downloaded to a computer, mobile phone, PDA or other device to carry out the methods described herein. The software can be a desktop application or a tool bar, and can track, store, and communicate the user's action. A tool bar application can be installed as part of the internet browser to track user's actions and stored metadata.

As stated herein, the source of user generated data includes the data along with information about the object to which it is attached or associated. A processor which is coupled to the source, associates or cross-references the user generated data with data, including metadata or links, of a second user in another environment, which is different from the environment in which the source user generated data was provided. An output device (e.g, a computer, a PDA, mobile phone, or navigation system) provides the user generated data to the second user.

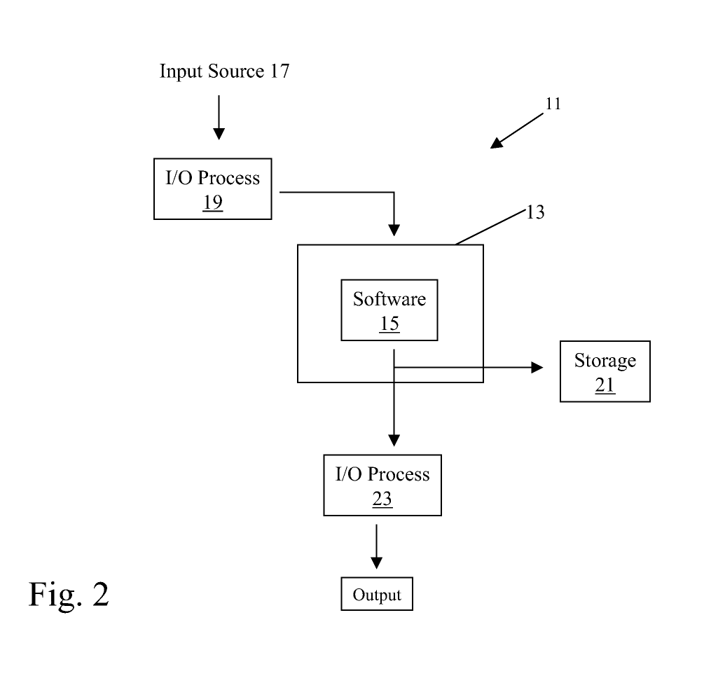

Referring to FIG. 2, a computer system embodying a software program 15 (e.g., a processor routine) of the present invention is generally shown at computer system 11. The computer system 11 employs a host processor 13 in which the operation of software programs 15 are executed (e.g., a program that allows for the association of user generated data from one type of environment to data input in another environment). An input device or source such as on-line data or a database of stored user-inputted data and the like provides input to the computer system 11 at 17. The input can be pre-processed by I/O processor 19 which queues and/or formats the input data, if necessary, as needed. The user inputted data is then transmitted to host processor 13 which processes the data through software 15. Using the input data, software 15 provides an output for either memory storage 21 or display through an I/O device, e.g., a work-station display monitor, a printer, and the like. I/O processing (e.g., formatting) of the content is provided at 23 using techniques common in the art. The computer system according to the invention is useful in applications including, but not limited to, providing user inputted data generated in one type of environment to a second user in a different type of environment. As described above, the computer system can employ any output device (e.g, a computer, a PDA, mobile phone, or navigation system).

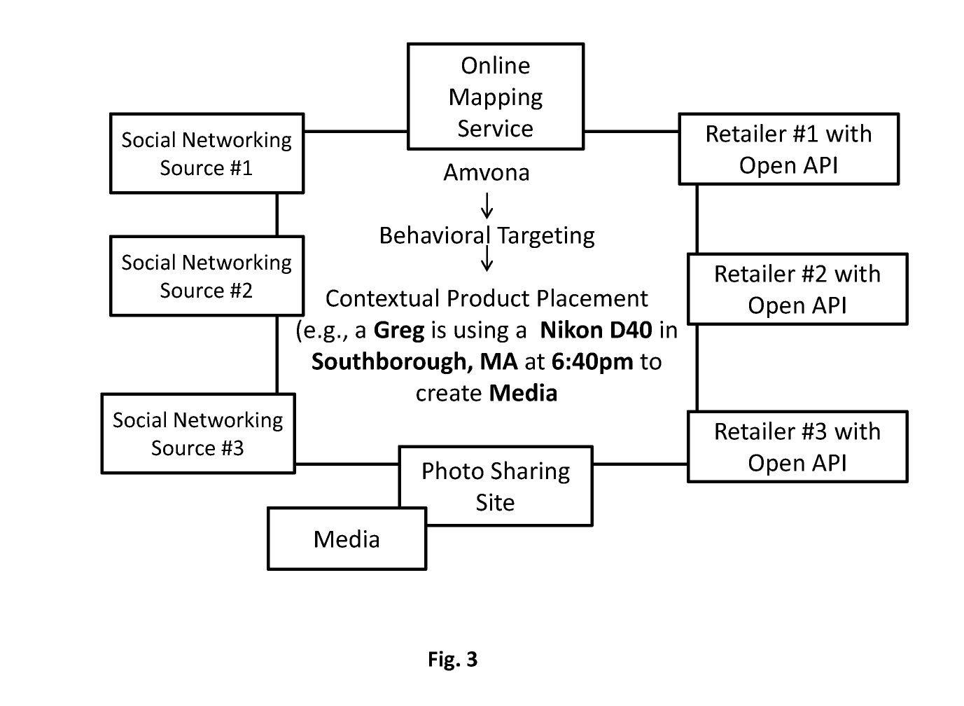

With respect to FIGS. 3-16, methods of integrating e-commerce and social networking data are carried out. This screen set is designed for users looking to purchase a camera (e.g., product information), users to explore different ways to take certain types of photographs (e.g., metadata associated with an object or media), users to explore photographs taken at specific locations (e.g., location or GPS data), or users looking for other users that take certain types of photographs (e.g., user information). Although this embodiment describes a photography application, integrating user information, product information and media or object content, and location information is encompassed by the present invention. The integration of these environments allows for the user to conduct more meaningful searches and/or obtain relevant results. Referring to the flowchart in FIG. 3, the integration employed in the methods described herein involves integrating user generated/inputted data and e-commerce information (e.g., product or retailer information). Metadata or media content can be generated from the user-side, from the e-commerce-side, or both, as described herein. Also as described herein, users can search for content and get results that have data from both environments. Alternatively, a user can access media from the user generated environment and get e-commerce information, and vis versa. In this embodiment, the addition of location metadata associated with the object (e.g., media) is specifically introduced, and refers to metadata identifying the location of where the image was taken. GPS or Global Positioning System data, with certain cameras, are automatically associated with media taken by the camera. The location metadata imbedded into the image is metadata commonly referred to a “geotag”. Alternatively, location information can be associated to the media by the user, e.g., after uploading the media. The location of the media can be associated with the user's location e.g., to sort the display or to choose which locations to display. The location of the user can further be associated with a location of a retailer e.g., that sells a camera, camera accessories, or one that can print the images.

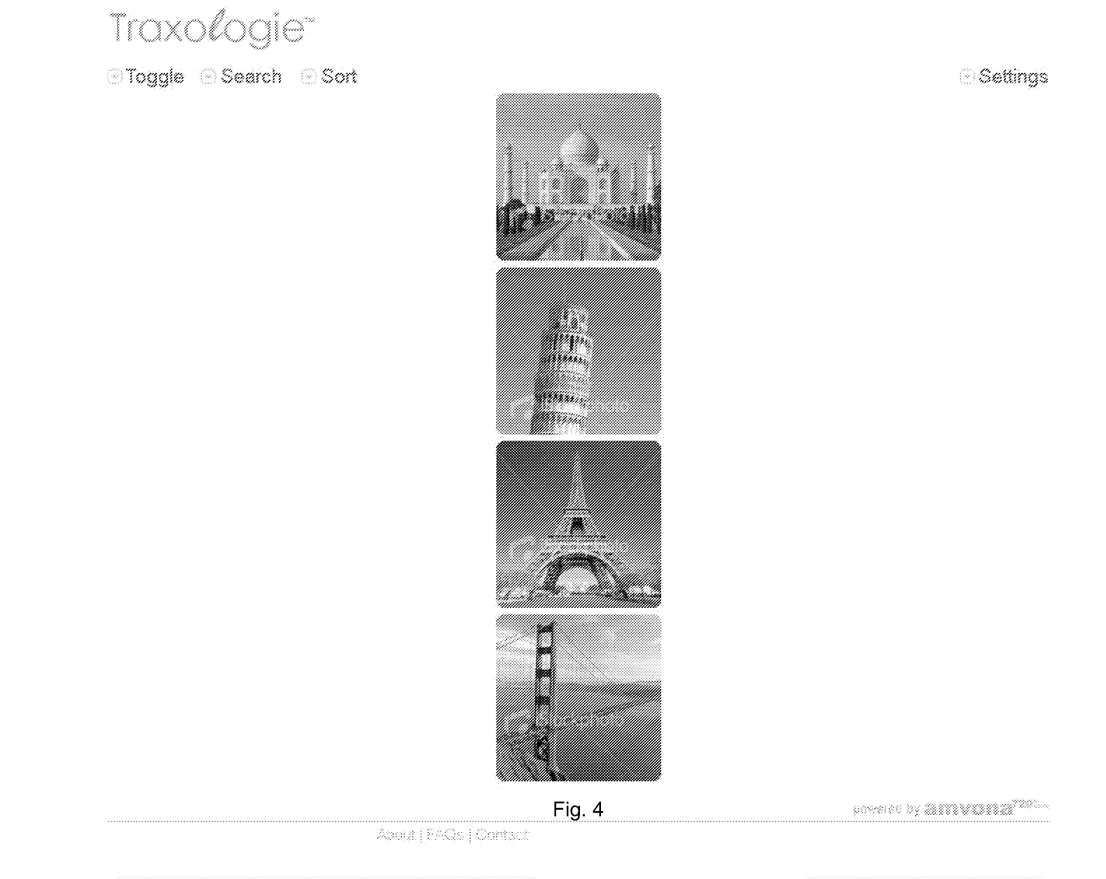

In particular, FIG. 4 shows a series of 4 photographs of famous locations including the Taj Mahal, Leaning Tower of Pisa, the Eiffel Tower and the Golden Gate Bridge. The screen can be made up of any number or type of photographs, but in this case famous locations were chosen. In FIG. 4, a predefined set of locations is being used to start the user off, but any image or object can be used and formatted in any number of ways. However, the default set of locations can be the most popular location (e.g., most clicked), locations near the user (e.g., based on the actual location associated with IP address of the computer, or location associated with a logged-in user), or locations with the most metatags associated therewith. In this case an image is being used, but any object, as defined herein, can be used in a similar manner. The objects shown can be modified by the user by using the “Settings” button, which will be further described herein. In this instance, the images of these locations are sorted by the number of tags associated with the location. However, objects can be sorted in any number of ways and can be defined by the user as well, and further described herein.

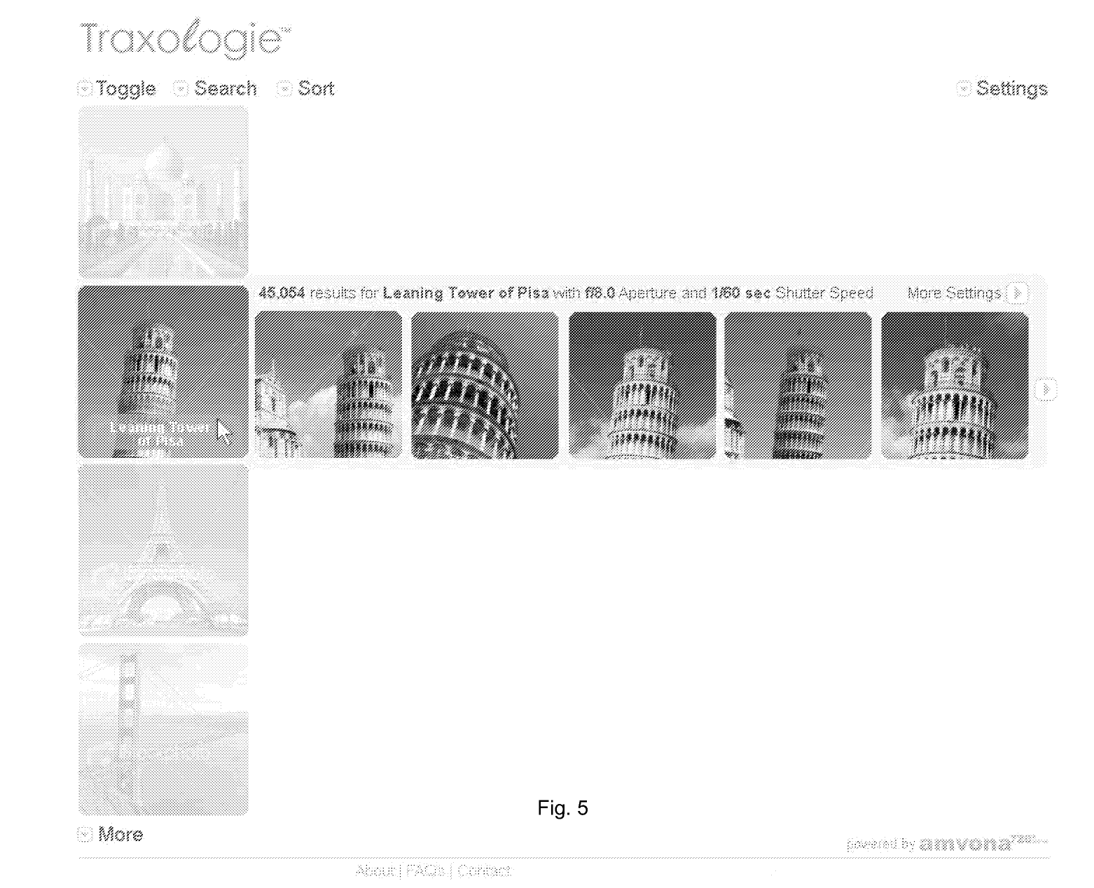

When the user clicks on one of the images such as the Leaning Tower of Pisa, as shown in FIG. 5, the images slide to the left and a series of photographs taken of the same location are shown in a slide show format. In this case, the images all have the same metatag “Leaning Tower of Pisa”. Although only images with the location metatag are shown, additional images (e.g., that of the user who took the image or images of the camera used to take the image) can be simultaneously shown below, above or in relation with the slide show images of the location. When the user rolls their mouse over the image, the metatag can be seen, as shown in FIG. 5. In this instance, the images included in the slide show, although having the same metatag, are sorted using a default setting. The default settings include certain photographic attributes. They were prioritized by photographic attributes having the largest number of images associated with it. Photographic attributes include, e.g., date and/or time the photograph was taken, location where the photograph was taken (e.g., GPS, longitude & latitude, physical address, its name), camera make and/or model, presence of a flash (e.g., flash or no flash), aperture, shutter speed, white balance, contrast, saturation, focal length, ISO speed and the like. Photographic attributes with some cameras are automatically embedded as metadata into images taken by the camera, as described herein, or can be manually associated by the user who uploads the media. For example, in this instance, the largest number of images was associated with a “no flash” attribute and hence “no flash” became the default. Approximately 45,000 images had a “No Flash” setting and about 25,000 images had a “Flash” setting. Then the setting with the next highest priority is set using the same logic. The default favors the greatest number of results by photographic attribute. The objects shown in the display can be sorted by any method, and can be modified by the user, as described herein. The figure also displays the number of results along with the location and default settings, which in this case included aperture and shutter speed.

In this embodiment, the images can be taken with different cameras. Hence, by comparing the images, the user can assess which camera takes better pictures, when all other variables (e.g., aperture, ISO, flash) are the same. The user is choosing the camera s/he wishes to purchase by comparing user-generated images taken by that camera, wherein the location and all other camera settings (photographic attributes) remain the same. This comparison provides a powerful way for a user to harness user generated data from both a social networking environment and an e-commerce environment such that the user cannot only decide which product to purchase, but also, as described more fully herein, the user can determine from which retailer the product should be purchased.

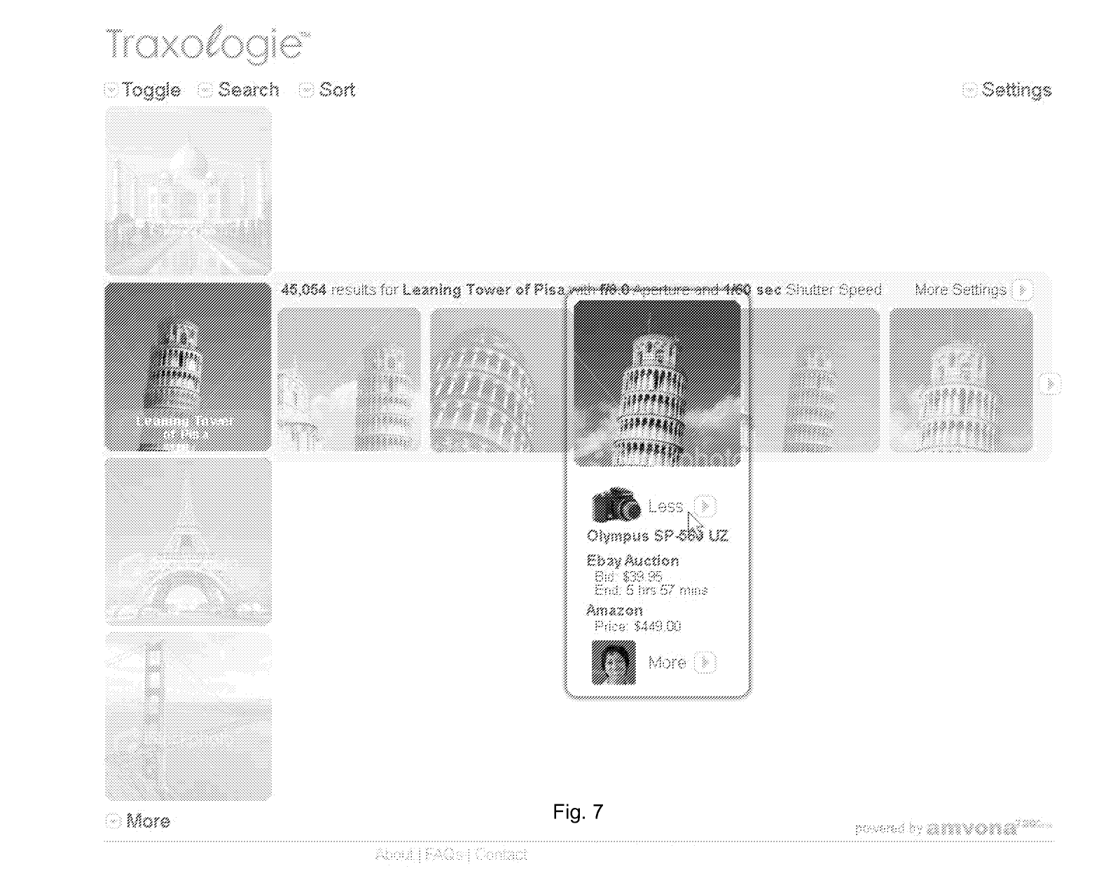

When the user rolls their mouse over one of the slide show photographs, a menu appears. The menus have product specific options, designated by an image of the camera, and user specific options, designated by an image of the user. In this case, the methods of the present invention associate metadata of the media with both product information (e.g., the type of camera used to take the photograph, retailers, etc.) and user information (e.g., user profile, other user images, etc.). When the user clicks on the “more” tab next to the product image in FIG. 7, product information including the name of the camera, retailers, cost of the product, and in case of an auction site, when the auction ends. In this case, FIG. 7 is showing on-line retailers, but in an embodiment, local retailers can also be shown. Local retailers can be determined in any number of ways and include for example: 1) the user indicating where to search for retailer (e.g., by entering a zip code or city and state), 2) by proximity to the location designated in the user's profile, and 3) by proximity to the location based on the IP address of the computer being used. Other product information or links thereto can be shown and include, e.g., reviews, ratings, sales, repair records, etc. By clicking on one of the retailers, the link can bring the user to retailer site.

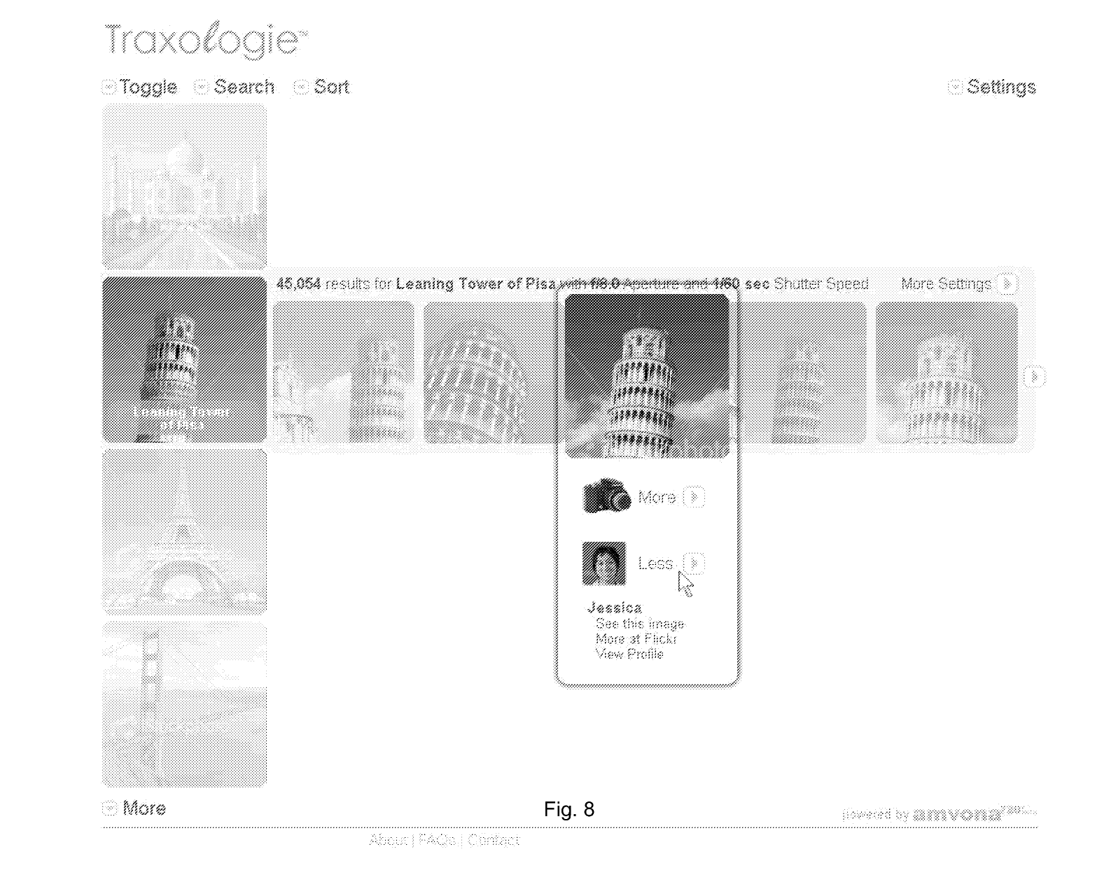

Similarly in FIG. 8, when clicking on the “More” button next to the user, Jessica, links to the image, a link to all of the user's photographs posted on a site, and the user's profile are provided. Any user inputted or user generated information or links thereto can further be provided, or links to engage the user can also be provided (e.g., send this user an email, or invite to be your friend).

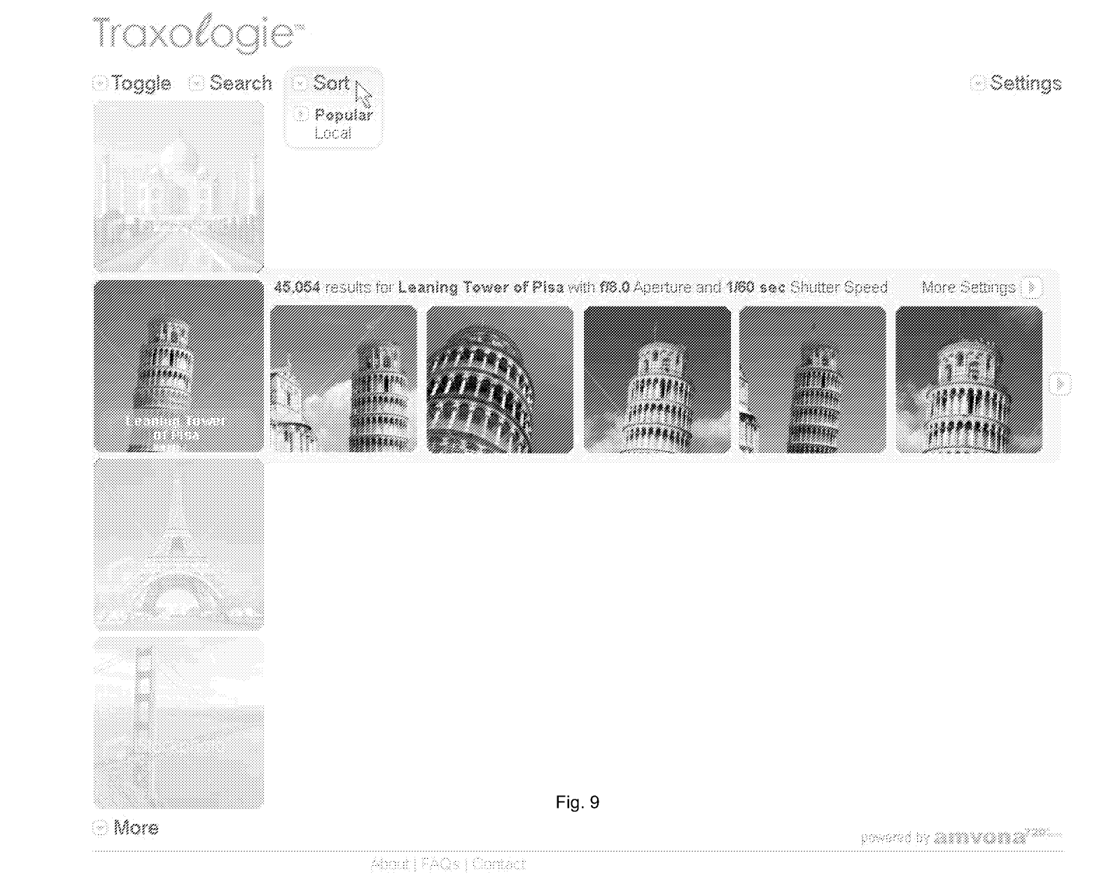

FIG. 9 shows an option called “Sort” in which the user can choose how to sort the images in the slide show. In the figure, the user has the option of sorting by the most popular (e.g., most clicked on) images anywhere (e.g., option: Popular), or popular images of things that are in the vicinity of the user (e.g., option: Local). Locations that are near the user can refer to locations indicated by the user in their profile (e.g., the user's home address, work address) or location based on the IP address of the user's computer. Additional sort options can be provided based on any piece of user generated information, and examples include images highest rated, most reviewed, most viewed, location, images of users in your network, or any combination thereof.

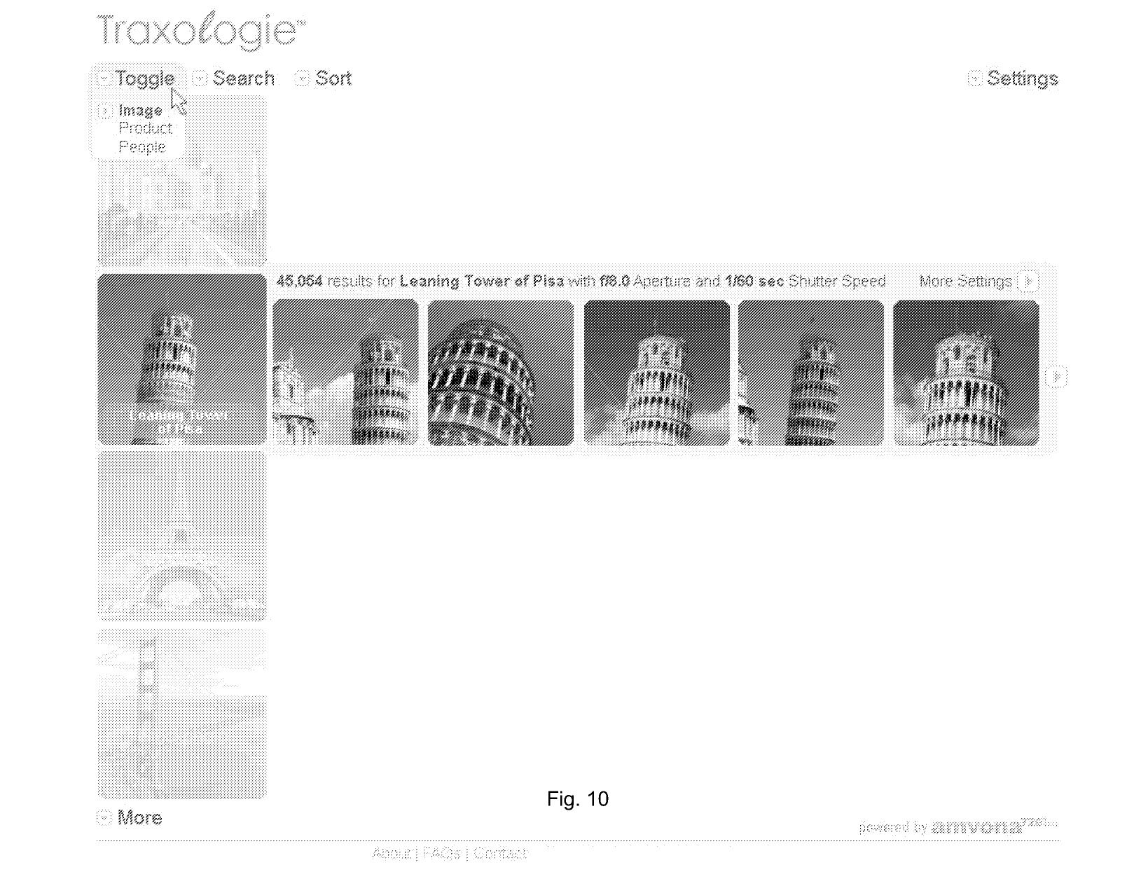

The slide show of images of the Leaning Tower of Pisa in the previous figures were obtained by using the default setting, which is automatically set to “Image”. When “Image” is selected, the display begins with selecting the image of some popular location. The toggle button in FIG. 10 also allows the user to view images of a particular location by selecting either the “Product” used to take the images, or by “People” (e.g., other users) who took the images. In this case, the product refers to cameras used to take the images. The Toggle button affects the four images to the left side of the page. So, if Product is selected, a series of camera images will appear on the left-hand side of the page, as described herein, but the results to the right are images with the “Leaning Tower of Pisa” metatags. In this embodiment, the “Toggle” changes the way the results are filtered.

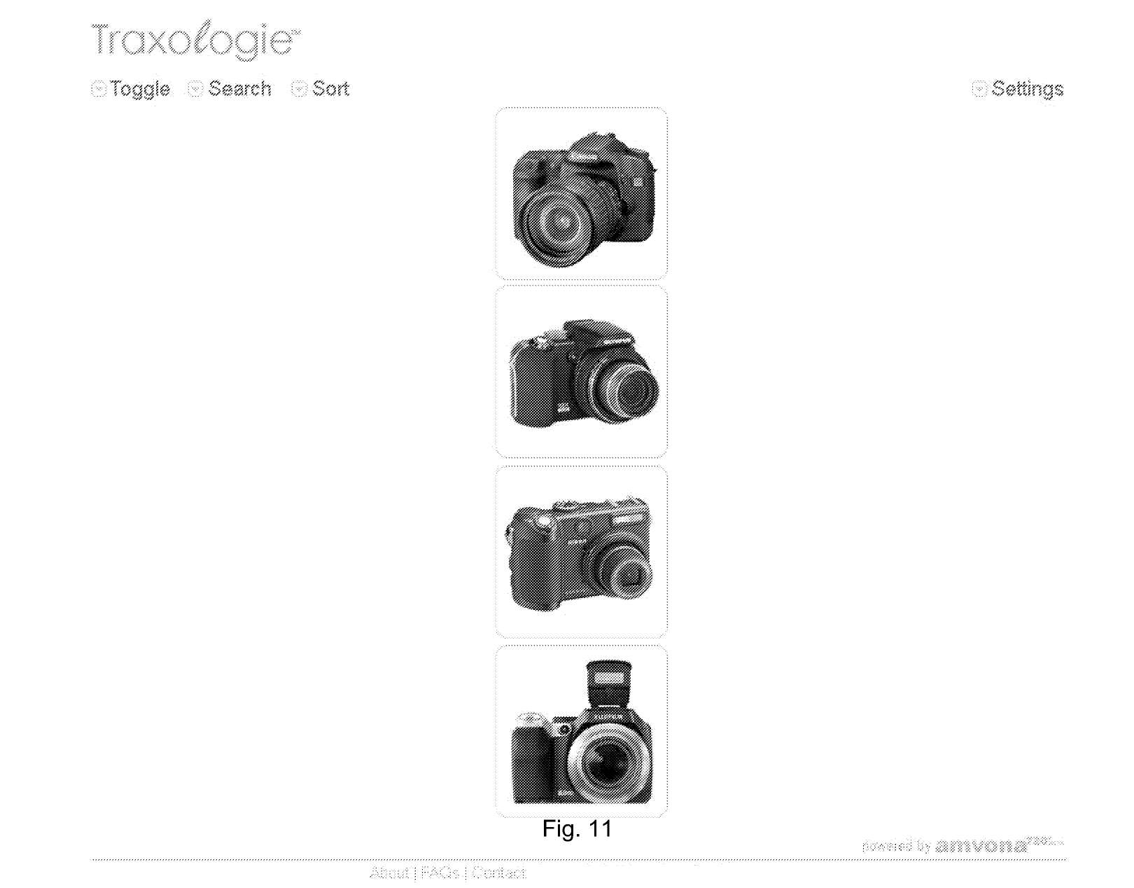

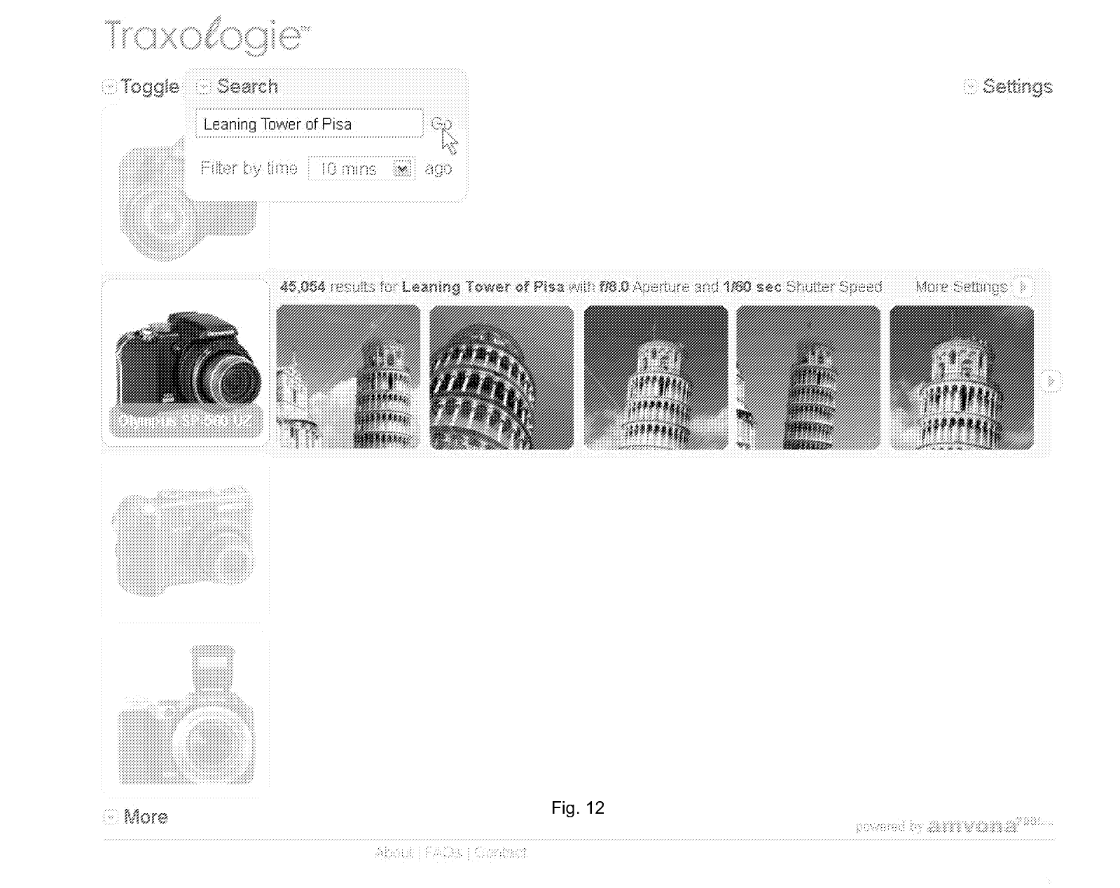

Hence when the Toggle is set to Product, the display begins with a series of camera images, as shown in FIG. 11. The camera images are shown when there are other images that include metadata for the location (e.g., Leaning Tower of Pisa) and the specific camera (e.g., product) being used. When the user clicks on the Olympus SP 560 UZ and enters the search string of “Leaning Tower of Pisa” and a time frame of 10 minutes, as shown in FIG. 12, a slide show of images taken at that location taken with this camera uploaded within the last 10 minutes is shown. A user viewing this slide show can view photographs taken by the same camera, and study the effect of changing other photographic attributes.

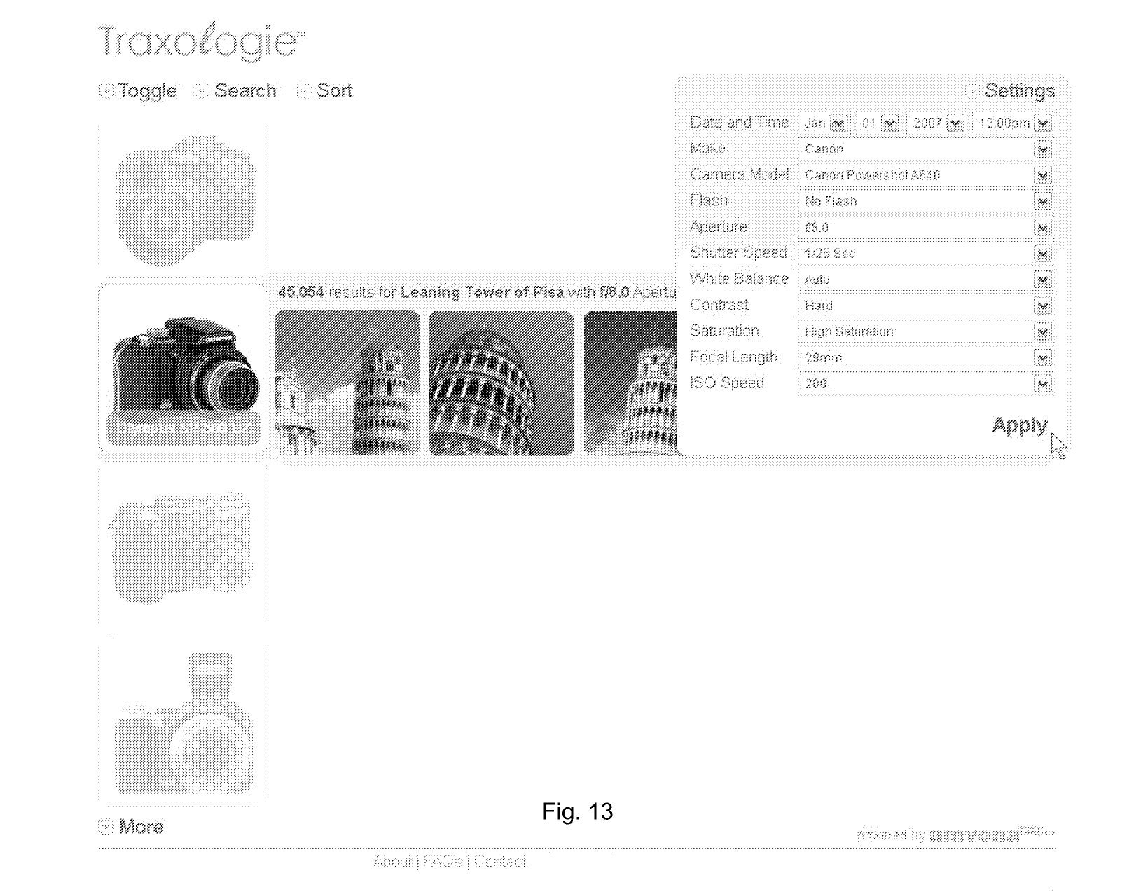

As shown in FIG. 13, the user can adjust photographic attributes using the Settings drop down menu. In this embodiment, the user can set the attributes for the images the s/he wants to see. For example, the user may want to determine how the Aperture affects the images using this particular camera and so the user can set all of the other attributes and hit “Apply”. The user can compare a change in the aperture affects images taken by the same camera, at the same location, with all other variables staying the same. Any attribute can be compared among the images. Also, a combination of attributes can be compared (e.g., ISO and shutter speed) to determine how their combination affects a photograph, where the rest of variables remain constant. In another embodiment, the user can determine the best settings to use on his camera at a particular time of day with the same camera at that location. The settings can be adjusted to find the exact look the user wants for his image by adjusting the settings and viewing the images.

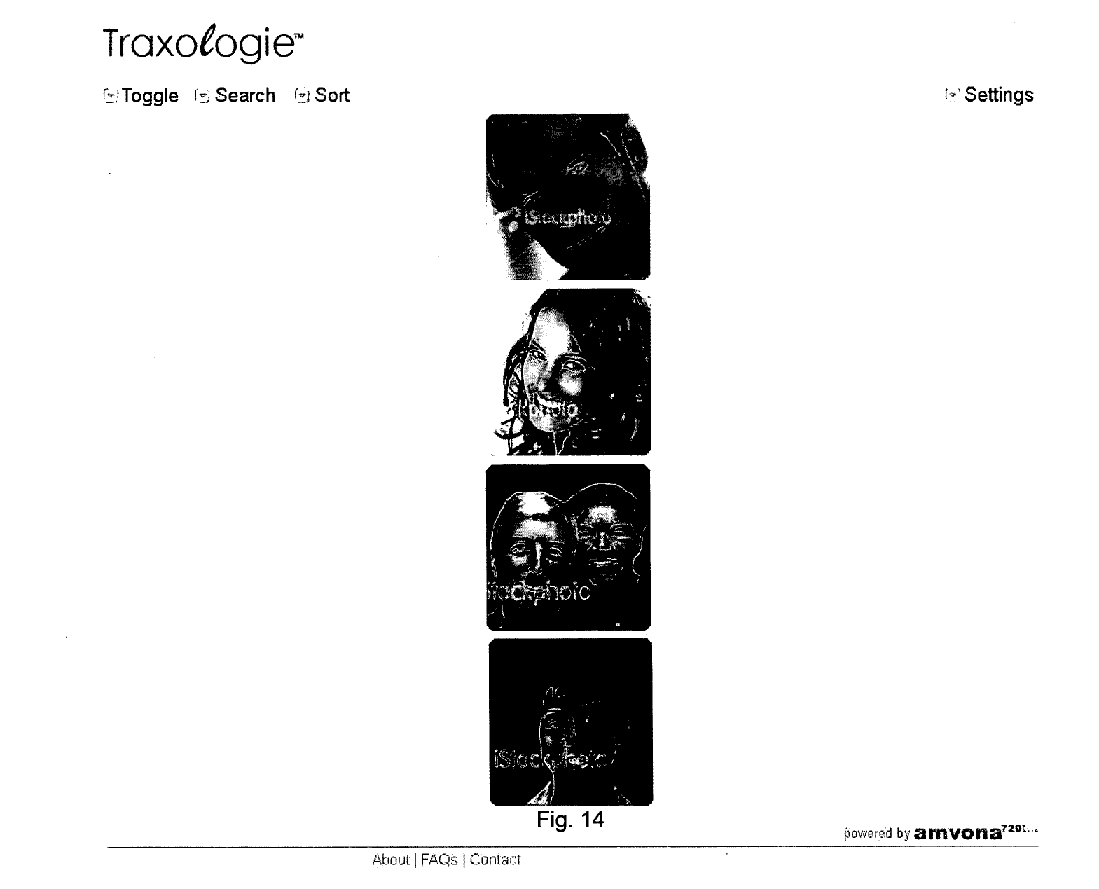

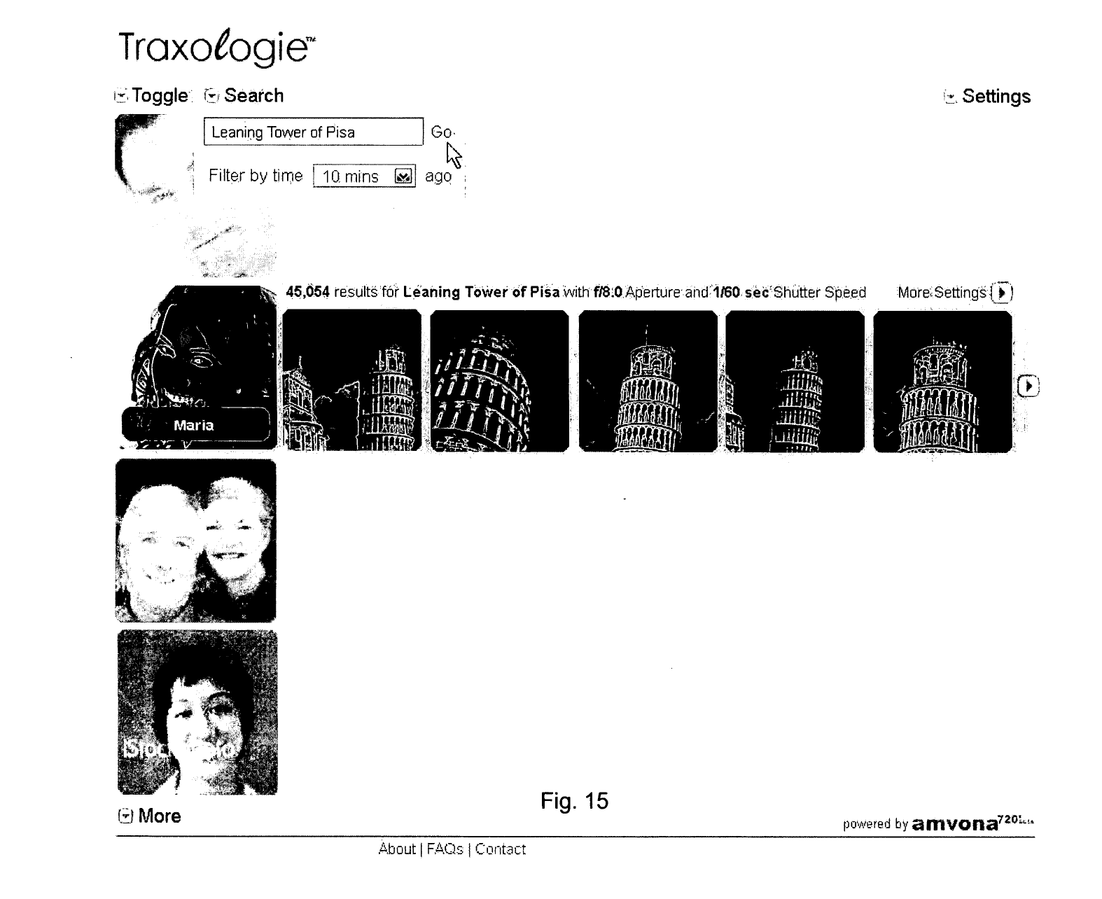

Similarly, FIGS. 14 and 15 allow the images to be viewed starting with the users who took the images. For example, the user can view images uploaded by a particular user, e.g., a well-known photographer. After searching for images having metatags of “Leaning Tower of Pisa” and a time frame of 10 minutes, a slide show of images taken by other users is provided. The images are sorted by the most popular people having images taken at that location (e.g., location metadata associated with the images).

This embodiment of the present invention can be carried out on a website that is part of the internet, e.g., as a web application, or downloaded to desktops, phones, cars with GPS capability and other devices with internet access that can download media described herein.

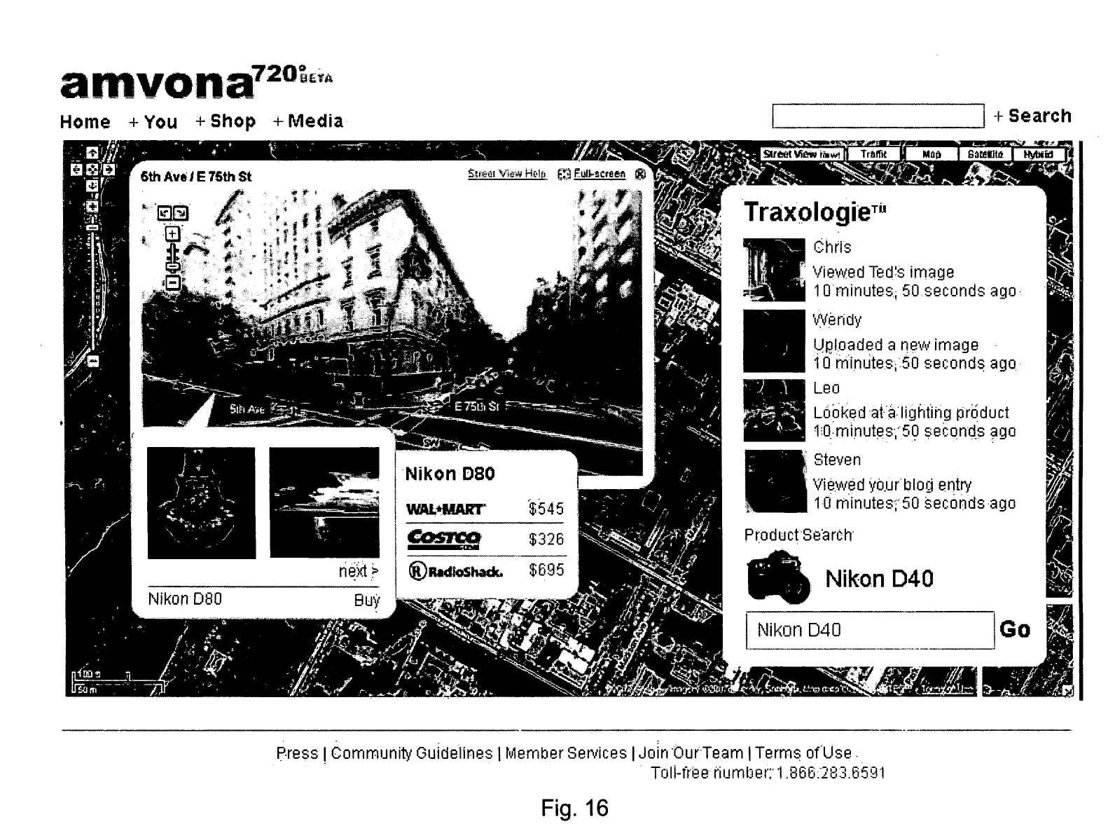

FIG. 16 is yet another embodiment that provides user results that include both generated/inputted data and e-commerce data. In this case, the user is searching for information about Nikon D40. The “traxologie” display is used to display users who have taken pictures with this particular camera. The “Traxologie” display is the subject of U.S. co-pending patent application Ser. No. 11/750,321, filed May 17, 2007, entitled “Methods, Systems and Apparatus for Displaying User Generated Tracking Information”. The user can click on any one of these users to view media uploaded by the user and taken by the particular camera. In addition to determining users who took pictures with the camera, the user can view users on a map. The user can click on other users based on their location and view pictures taken with the Nikon D40. In FIG. 16, the user click on another user, as shown on the map, and images taken by that user with the Nikon D40 are shown. A series of three images is shown, one larger and two smaller ones. Although the images are shown in this fashion, any method of displaying images can be done (e.g., in a slide show format). Furthermore, retailers that sell the Nikon d80 and the price of the camera are shown. The map has features that allow the user to view streets, traffic, satellite images, or a hybrid thereof. Additionally, rather than showing where users are located on a map, locations of where images are taken can be shown. For example, a user can conduct a search for the Nikon D40, and a map is provided indicating (e.g., with icons) where images were taken with the camera. The users who took the image can also be display, e.g., in a traxologie display as shown. This figure provides yet another embodiment that provides and integrates both user-generated media content and e-commerce information (e.g., product information), and in this case, is provided with location information. Location data refers to information that provides a physical location of either the user, the location of the device used to access the internet (e.g., computer, cell phone, PDA, etc.), the location of products or services, or the location related to the object (e.g., where an image or video was taken). Location data can be in the form of GPS information, a physical street address, its name (e.g., Leaning Tower of Pisa), longitude/latitude coordinates, or any other data that communicates a physical location. The location can be displayed on a map, or by describing the location.

Although these figures use location information associated with the image, an embodiment of the invention relates to methods that are carried out independent of image-associated location information. For example, a user may want to compare certain types of images when purchasing a camera or determining what camera settings to use. In an embodiment, the user can have the option of choosing or searching for certain types of photographs, choosing photographic attributes or using default settings, and making the comparisons. Examples of types of photographs include those with flowers, people, family, pets, models, beaches, sunsets, etc. The user can search for any metadata they so choose, or the website can provide the most popular tags (e.g., most clicked), highest rated, most reviewed. Additionally, certain algorithms can be employed to provide more interesting but less popular images. Methods for providing images include those described in related U.S. patent application Ser. No. 11/674527, filed Feb. 13, 2007, entitled “Methods and Systems for Displaying Media”, the entire teachings of which are incorporated herein by reference. Any type of image can be compared, as described herein.

### EXEMPLIFICATION

### Example 1

### Integration of Social Networking and E-commerce

As described herein, exchange of data between a social networking environment and an e-commerce environment occurred on a site and was referred to as “Traxologie” exchange or display. In an e-commerce environment, a user that has a user ID (ID #7777777777) and a profile, clicked on a product (model #: AT 3770 Traveler Tripod by DynaTran). When the user viewed this product, a list of other users that also viewed this product was also displayed. The list was sorted in reverse chronology, listing the most recent user to view the product first. Along with the user's ID and photograph, the length of time since the view was also display. The length of time since the viewing was periodically updated as time passed. The display also provided a link to send users on the list a message, or to add them to your network as a friend. The user can click on any other user to see their profile. Comments and ratings of the product by users were also listed.

Integration of e-commerce into the social networking environment occurred as well. When viewing user ID's profile (ID #7777777777), a display of products (including model #: AT 3770 Traveler Tripod by DynaTran) viewed by the user was displayed along with any user profiles viewed by her. The display had the user ID and photo of the user who did the viewing, the length of time that had passed since the viewing, a description of what was viewed, and if a user's profile was viewed, links to send the user a message or add them to your network. Additionally, when the current user clicked on the description of what was viewed or placed a mouse over it, then the product image was viewed. The length of time since the viewing was periodically updated as time passed.

### Example 2

### Contextual Product Placement

The screens shown in FIGS. 4-16 were created and used in the following manner. Using AJAX application and an open API, the screens shown in FIGS. 4-16 were created and the methods described herein were carried out. The following is a description of how each of the specific screens worked:

FIG. 4: This is what one would see when s/he first visits the site. The four images in the middle are the four most popular locations (that images have been submitted for from around the world). The column of images moves to the left where it becomes docked to the side of the page. (The user can also sort to show the top locations that images have been submitted for that are near your location by using the “sort” button—also discussed below).

FIG. 5: In this example the user has rolled over one of the large images, and this produces the name of the location in a transparent rollover box on top of the large image. Also, a gray drawer containing images will slide out from behind the large image. The number of results along with the location and the default settings for Aperture and Shutter Speed (the default settings that are displayed could change—shutter speed and aperture are used only for example purposes).

The logic involved default settings that were determined by prioritized list of settings that have various options. The option that had the most images was selected as the default. For example, our setting with the highest priority is Flash/natural light. In this example, this setting has about 45,000 images that have No Flash, and about 25,000 images that have a Flash. So, No Flash becomes the default, because it has the most images. Then, the setting with the next highest priority is set using the same logic. This continues until all the settings have been set. So, default favors the greatest number of results by setting. The final results set would be the largest number of images with the same location tag and identical camera settings.

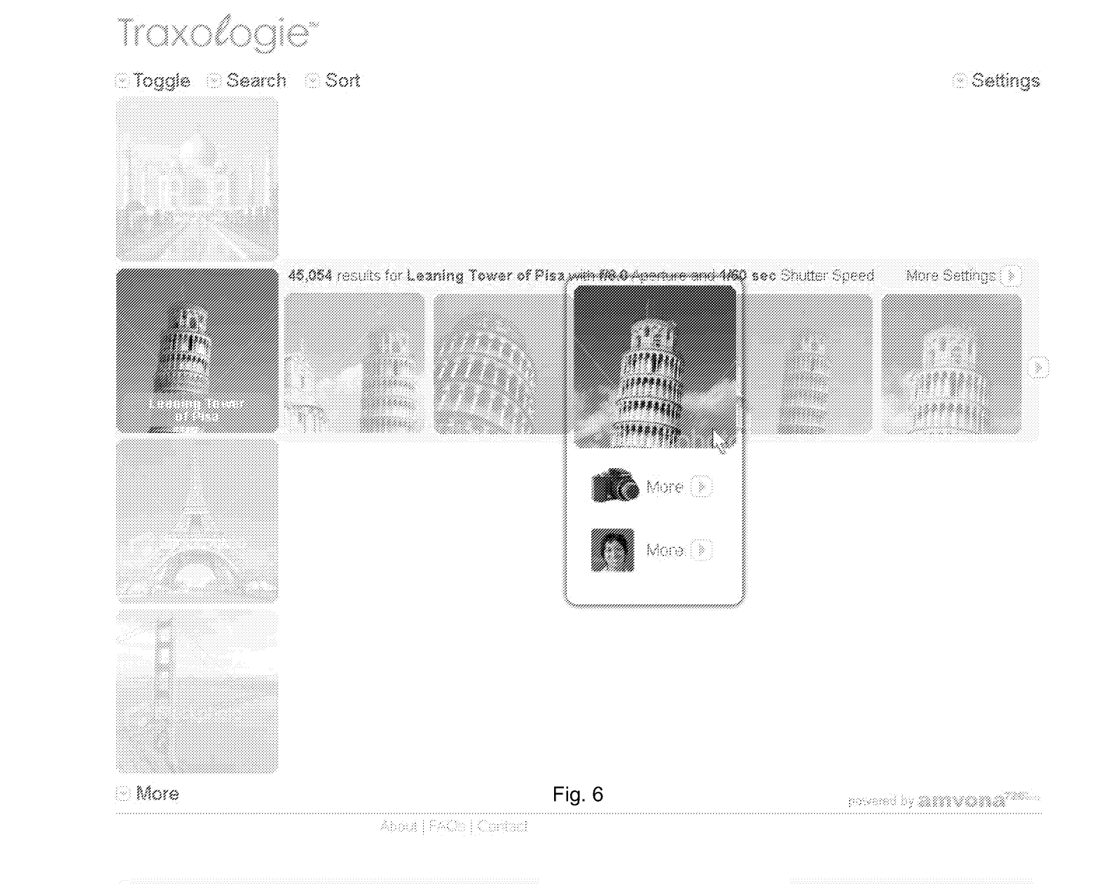

FIG. 6: In this example, the user has rolled over one of the smaller images producing a menu that gives a magnifying effect for the image. The menu has two items, one for the camera that took the image and one for the person that took the image. Clicking on “More” for either item will give the user basic information about either the item or the person.

FIG. 7: In this example, the user has clicked on “More” for the Camera. This produces the name of the camera along with EBay Auction and Amazon listings to purchase the camera. The EBay Auction listing shows the current bid and the time that the auction will end. The Amazon listing shows the current price. Clicking on either of the listings will take you to the EBay and Amazon sites respectively. Clicking on Less will hide the listings.

Note: eBay and Amazon are used only for example purposes—any ecommerce platform with open API's could be used.

FIG. 8: In this screen example, the user has clicked on “More” for the Person. This produces the user's name, a link to the image, a link to all of the user's photos, and a link to the user's profile (on the related social network from which the user data was pulled). Clicking on “Less” will hide the information.

FIG. 9: On this screen, the user has selected Sort from the top menu. This produces a menu with the options Popular and Local. These selections affect the four large images that are docked on the left of the page. When Popular is selected, images for the four most popular locations are displayed. However, when Local is selected, images for the four most popular locations in your area are displayed.

Note: The number of results displayed can be increased incrementally by clicking on “more” at the bottom of the results set. The radius from your current location (based either on zip code if logged in, or IP address if not) can also be set—e.g., radius around said location (e.g. 1 mile, 5 miles, 10 miles, 15 miles, etc.)

FIG. 10: In this example the user has selected Toggle from the top menu. This produces a menu with the options Image, Product, and People. These selections allow the user to choose how he/she would like to browse (for the related tag). The four large images that are docked on the left side of the page change according to the option. For example, selecting Product produces the four top cameras for that location tag—in this case “Leaning Tower of Pisa”. This change can be seen on the left hand side as the four large images become images of the cameras themselves. Please, note that the result (in this example “Leaning Tower of Pisa”) does not change based on the Toggle. The Toggle only changes the way the result is filtered. In this case the top cameras for which images of “Leaning Tower of Pisa” can be found, for the specified time period (e.g. last 10 min., last hour, last week etc.)

FIG. 11: In this screen example, the Toggle from the top menu has been switched to Product. This change can be seen as the four large images become images of the cameras instead of the images of the locations. Whenever a new Toggle option is selected, the four main images reset to the center, then the column of images moves to the left where it becomes docked to the side of the page.

FIG. 12: In yet this example, the user has selected Search from the top menu and has entered “Leaning Tower of Pisa” into the search box. The search function allows you to see results for either Images, Products, or People (the Toggle options) based on upload time. Also, the default upload time changes to produce a preset minimum of results. For example, the user is interested in buying a camera, so the Toggle has been set to Product. Then the user can search for something he/she knows well to see how the camera performs based on what they know about the location, object, etc they have searched for that were uploaded in the selected timeframe.

FIG. 13: In this figure, the user has either selected Settings from the top menu or has selected More Settings from the top right of the gray slider drawer. The settings allow you to filter the results you get from searches. For example, the user is planning a trip to Italy and wants to photograph the Leaning Tower of Pisa, and so they have searched for the Tower. However, now the user wants to know the best settings to use on his camera at 2:00 pm in mid-October (the time of his expected visit to the site) with the same camera that he or she plans to take the picture with. The Settings can be adjusted to find the exact look the user wants for his/her image by adjusting the settings.

FIG. 14: In this example, the Toggle from the top menu has been switched to People. This change can be seen as the four large images become images of the people instead of the images of the cameras. Whenever a new Toggle option is selected, the four main images reset to the center, then the column of images moves to the left where it becomes docked to the side of the page. Again the default is the top people who have submitted images in the pre-set time frame (e.g. last ten minutes, last day, etc.) results can further be filtered by selecting “local” then the desired radius from either the users zip code or from IP address.

FIG. 15: In this example, the user has selected Search from the top menu and has entered “Leaning Tower of Pisa” into the search box. The search function allows you to see results for either Images, Products, or People (the Toggle options) based on upload time. For example, the user is interested in finding other people who took pictures of the Leaning Tower of Pisa. So, after changing the Toggle to People, the user searches for the Leaning Tower of Pisa. The results are based on the most popular people with the most pictures containing that keyword.

All options are available for all Toggles. It is also important to note that the entire method can be manifested as a website and/or a web application which could be portable. This application would also work great as a widget that could be posted on blogs or other social networks.

This application relates to U.S. application Ser. No. 11/750,321, filed May 17, 2007, entitled “Methods, Systems and Apparatus for Displaying User Generated Tracking Information”. This application also relates to U.S. application Ser. No. 11/674,516 filed Feb. 13, 2007, entitled “Social Networking and E-commerce Integration” by Greg M. Lemelson.

The relevant teachings of all the references, patents and/or patent applications cited herein are incorporated herein by reference in their entirety.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of providing data and one or more objects in an online environment, the method comprises:
a. providing an object having user inputted or user generated metadata, location metadata and product metadata of a product, wherein the user inputted metadata and product data is associated with the object or is imbedded into the object; and
b. providing one or more pieces of product information about the product, wherein the information relates to retailers, cost of the product, location of the product, repair information about the product, or reviews, ratings or reviews about the product.

2. The method of claim 1, wherein the product data is inputted by the user or generated by the user.

3. The method of claim 2, wherein the product relates to photography equipment, cameras, mobile devices, personal digital assistants, or accessories therefor.

4. The method of claim 3, wherein the object is a image or video.

5. The method of claim 4, further including information about the user who uploaded the object, links to the user's profile, or links to communicate with the user.

6. A method of providing data and one or more images in an online environment, the method comprises:
a. providing an image having user inputted metadata, location metadata, and product data of a product, wherein the user inputted metadata and product data is associated with the image or is imbedded into the image;
b. providing one or more pieces of product information about the product, wherein the information relates to retailers, cost of the product, location of the product, repair information about the product, or reviews, ratings or reviews about the product;
wherein the images provided can be filtered by one or more settings defined by the user.

7. The method of claim 6, wherein the settings are photography attributes that comprises date and/or time the photograph was taken, location where the photograph was taken, camera make, camera model, presence or absence of a flash, aperture, shutter speed, white balance, contrast, saturation, focal length, ISO speed, or any combination thereof.

8. The method of claim 7, further including conducting a search of metadata associated with said images, wherein results of the search contain the images having metadata relating to or matching search criteria.

9. A system for providing data and one or more objects in an online environment, the system comprises;
a. one or more sources of one or more objects having user inputted or user generated metadata, location metadata and product metadata of a product, wherein the user inputted metadata and product data is associated with the object or is imbedded into the object; and one or more pieces of product information about the product, wherein the information relates to retailers, cost of the product, location of the product, repair information about the product, or reviews, ratings or reviews about the product;
b. a processor, coupled to the source, that associates said user inputted or user generated metadata with said one or more pieces of product information;
c. an output device that provides results of user inputted or user generated metadata with said one or more pieces of product information.

10. The system of claim 9, wherein product relates to photography equipment, cameras, mobile devices, personal digital assistants, or accessories therefor.

11. The system of claim 10, wherein the object is a image or video.

12. The system of claim 11, wherein the results include images that are filtered by one or more settings defined by the user.

13. The system of claim 12, wherein the settings are photography attributes that comprises date and/or time the photograph was taken, location where the photograph was taken, camera make, camera model, presence or absence of a flash, aperture, shutter speed, white balance, contrast, saturation, focal length, ISO speed, or any combination thereof.
